(19) United States
(12) Patent Application Publication
(10) Pub. No.: US 2006/0061545 A1
(43) Pub. Date: Mar. 23, 2006

(54) Motion-activated control with haptic feedback

(75) Inventors: Stephen Hughes, County Dublin (IE); Ian Oakley, Isle of Lewis (GB); Jussi Angesleva, Berlin (DE); Maure Sile O'Modhrain, Dublin 8 (IE)

Correspondence Address: CHARLES G. CALL, 68 HORSE POND ROAD, WEST YARMOUTH, MA, 02673-2516, US

(73) Assignee: Media Lab Europe Limited ( In Voluntary Liquidation)., Dublin (IE)

(21) Appl. No.: 11/122,631

(22) Filed: May 5, 2005

Related U.S. Application Data
(63) Continuation-in-part of application No. 11/096,715, filed on Apr. 1, 2005, now abandoned.
(60) Provisional application No. 60/559,362, filed on Apr. 2, 2004.

(51) Int. Cl. G09G 5/00

(52) U.S. Cl. 345/156

(57) ABSTRACT

A mechanism for sensing the changing positional and orientation of a hand held device as it is moved by the device user to control the state or operation of the hand held device and one or more vibrotactile transducers positioned on the body of the hand held device to provide haptic feedback stimuli to the user indicative of the state of the device. The mechanism employs the combination of accelerometers for obtaining inertial data in three degrees of freedom, gyro sensor for obtaining roll, pitch and yaw angular motion data, a GPS system for providing position data, and magnetometers for providing directional data. This sensor data may be used to control the functioning of the hand held device; for example to control display scrolling, and the vibratory stimuli fed back to the user provides an indication of the effects of the gestural movements the user imparts to the device.

### CROSS REFERENCE TO RELATED APPLICATIONS

This application is a continuation in part of copending U.S. patent application Ser. No. 11/096,715 filed on Apr. 1, 2005 by Maire Sile O'Modhrain, Ian Oakley, Stephen Hughes and Cormac Cannon, entitled “System for creating, broadcasting and reproducing haptic and audiovisual program content,” which claimed the benefit of the filing date of U.S. Provisional Patent Application Ser. No. 60/559,362 filed on Apr. 2, 2004.

This application further application claims the benefit of the filing date of U.S. Provisional Patent Application Ser. No. 60/566,593 filed on May 6, 2004.

The disclosures of each of the above identified applications is incorporated herein by reference.

### FIELD OF THE INVENTION

This invention relates to a handheld electronic device for sensing gestures by, and providing vibrotactile feedback to, the device user.

### BACKGROUND OF THE INVENTION

In the description which follows, frequent reference will be made to published papers reflecting related prior work by others. The citations to these references are presented in a numbered listing under the heading “References” at the end of this specification, and references to individual papers will be made hereinafter in curly brackets having the form {See Ref. n} where n is the number or numbers of the items in that listing.

The advent of mobile computing is demanding the development of new interaction techniques. As devices become more and more sophisticated, the desk-based metaphors underlying modern GUIs are becoming less and less appropriate as a control interface. The small screen and pen-based cursor prevalent in PDAs is not an ideal interface for mobile interaction {See Ref. 1}. Typically a user must stop, and focus entirely on the device in order to perform a task. In this regard, many mobile interfaces resemble transportable desktop interfaces, and not interfaces designed specifically for mobile scenarios. They represent an adaptation of an established interaction paradigm to a new situation, and not a solution designed to fit its particular constraints. Indeed there is a growing sense that a requirement in the field of handheld devices is the development of new interaction techniques specifically for mobile scenarios {See Ref. 2}.

Reflecting this observation, there is a growing research interest in the addition of novel sensing functionality to handheld computers in order to support new forms of interaction. One area that shows specific promise is input derived from movements of the handheld device. As Rekimoto {See Ref. 3} points out there are many advantages to using movement as input in a handheld situation, not least that it supports single handed interaction (as a user is already holding the device) and that it offers a rich input channel composed of three Degrees Of Freedom (DOF) translation and three DOF rotation, sufficient to support complex input such as gesture recognition. These qualities have led a number of researchers to design movement-based input techniques {See Ref. e.g. 4-6}. However, one significant disadvantage of using motion as input in a handheld scenario is that it limits the usefulness of the visual display for the duration of the input; as the user is moving the device, they are unable to clearly see its screen. Consequently, we believe that non-visual feedback will be an essential component of movement-based interaction techniques. Vibrotactile feedback in particular seems suitable for this role as it can be discretely presented directly to a user's hand, and is already prevalent in mobile devices.

One of the simplest interactions supported by movement is scrolling, and it has been discussed a number of times in the literature. Reikimoto {See Ref. 3} introduced a variety of interaction techniques facilitated by the addition of gyroscopic tilt sensors to a PDA. Perhaps the most compelling was navigating around a large 2D space (a map) by titling the device in the desired direction of movement. Harrison et al. {See Ref. 4} examined how tilt input might be used to control position in a list, and found that users had problems monitoring their progress. They tended to overshoot their intended locations, and experienced difficultly making small adjustments to their position, such as moving to adjacent items. Hinckley et al. {See Ref. 5} discuss how tilt might be used for scrolling, and consider some practical issues such as the fact that screen brightness can be severely diminished at non-optimal viewing angles, and the potential benefits of restricting the dimensionality of the input to facilitate better control. They also report that users reacted positively on the idea of controlling scrolling with tilt, preferring it to button based alternatives. Finally, Poupyrev et al. {See Ref 6} describe a study of tilt based scrolling in a list. Two conditions are compared, one featuring vibrotactile feedback on the transition between list items, the other without such feedback. Even with this very simple display, the results indicate that improvements in objective performance can be achieved.

There is a further need for devices capable of delivering multimodal content that combines haptic, visual and auditory media streams with gestural input. This capability is expected to be particularly useful in connection with the delivery of music and sports to mobile hand-held devices, as the “Touch TV” arrangement described in detail the above noted co-pending U.S. patent application Ser. No. ______ designated by Attorney Docket No. E-25 and Media Lab Europe Case ID: MLE-100 filed on Apr. 1, 2004 entitled “System for creating, broadcasting and reproducing haptic and audiovisual program content” filed by Maire Sile O'Modhrain, Ian Oakley, Stephen Hughes and Cormac Cannon.

A further example is the “Comtouch” vibrotactile communication technique disclosed in U.S. patent application Ser. No. 10/825,012 filed on Apr. 15, 2004 by Angela Chang, Hiroshi Ishii, James E. Gouldstone and Christopher Schmandt entitled “Methods and apparatus for vibrotactile communication.” In that arrangement, one or more actuators manipulated by a human sender generate an output signal sent via a transmission channel to a remote location where it is used to control a stimulator that produces vibrations perceptible to a human receiver that indicate the nature of the original action performed by the human sender. The ability to capture an “touch signal” from a sender and encapsulate its expressive nuance in a haptic message which can be relayed alongside a visible text message, or as an extra channel of sensory information accompanying a phone conversation, is likely to significantly enrich the experience of remote interpersonal communication. See also, Oakley, I. and O'Modhrain, S. “Contact IM: Exploring asynchronous touch over distance,” Proceedings of CSCW, New Orleans, USA, 16-20 Nov. 2002, which describes a Haptic Instant Messaging (HIM) framework that combines communication of textual instant messages with haptic effects.

The present invention extends this prior work by considering the design of tilt scrolling interfaces in two different scenarios. In each scenario the scrolling is supported by tightly coupled interactive vibrotactile feedback. It is one object of the invention to provide scrolling interactions such that they can be monitored non-visually so that the combination of proprioceptive feedback (inherent in motion interfaces) and dynamic vibrotactile display is sufficient to represent the state of the interface. Users should be able to gauge the state of their scrolling operation by feel alone.

While mobile phone companies have offered mobile phones with higher fidelity haptic output devices, there is a need for devices that combine gestural input and haptic output.

### BRIEF DESCRIPTION OF THE DRAWINGS

In the detailed description which follows, frequent reference will be made to the attached drawing, in which:

FIG. 1 is block diagram of a sensing and vibratory feedback mechanism embodying the invention.

### DETAILED DESCRIPTION

We have designed a hardware platform called “MESH” (Modality Enhancing Sensor-pack for Handhelds) which embodies the principles of the invention. Physically, the platform takes the form of an expansion jacket that can be used with a PDA such as the Compaq iPAQ. The iPAQ is a small form-factor, multimedia-centric PDA with versatile expansion capabilities. It has incorporates a high resolution LCD display screen, audio output to phone jack an expansion pack connector, a built-in mono microphone and speaker, a high performance/low power CPU, up to 32 megabytes of SDRAM, up to 32 megabytes of flash ROM, touch panel input, function/application buttons/switches, FIR/SIR, a RS-232C serial port, a USB client port, a notification/battery charger LED, and an expansion pack interface connector.

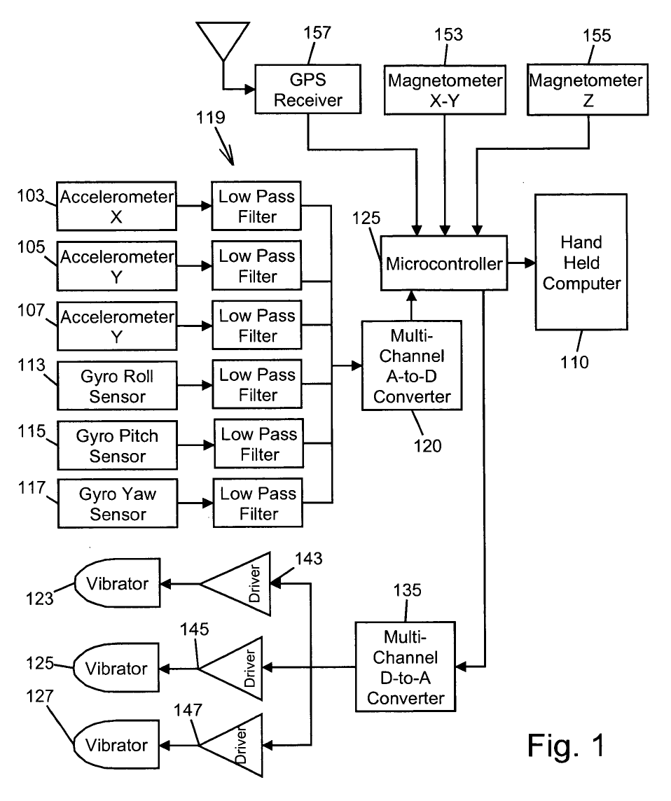

The iPAQ PDS is fitted with an expansion jacket that provides custom sensing and affecting electronics, augmenting the functionality of the PDA. The hardware components of the expansion jacket are shown in the block diagram, FIG. 1.

Accelerometers seen at 103, 105 and 107 provide the main sensor input within MESH. There are three accelerometers, each mounted along orthogonally and in line with the principle axes of the IPAQ 110. Suitable accelerometers include the ADXL202E. a low-cost, low-power, complete 2-axis accelerometer with a measurement range of ±2 g available from Analog Devices, Inc., One Technology Way, Norwood, Mass. 02062-9106. The ADXL202 can measure both dynamic acceleration (e.g., vibration) and static acceleration The frequency response of the devices extends to DC, allowing the acceleration due to gravity to be monitored. This supports high-resolution sensing of device orientation. Their bandwidth stretches to 100 Hz, yielding sufficient temporal resolution to capture data to drive gesture recognition algorithms. The sensing capability is further enhanced by using three gyroscopic roll angular motion sensors: a roll sensor 113, a pitch sensor 115 and a yaw sensor 117. For this application, the data is gathered from the sensors at 100 Hz, and transmitted over an RS232 serial link to the IPAQ. Signals outside the 100 Hz. bandwidth are suppressed by low pass filters seen generally at 119 which are connected between the sensors and a multi-channel digital-to-analog converter 120 the provides digital signal values from each sensor a microcontroller 125.

The vibrotactile display within MESH consists of two main elements: the vibrotactile transducers seen at 123, 125 and 127 and a sample playback circuit implemented using the microcontroller 125 driving an multi-channel analog-to-digital converter 134 whose outputs are connected to driver amplifiers 143, 145 and 147. The transducer is a VBW32 {See Ref. 7}, sold as an aid for hearing impaired people. It is modified (by rewinding the solenoid with a larger gauge wire) to operate at a lower voltage, which enables it to be powered by the iPAQ's battery. To characterize its display capabilities, we conducted an informal five user study within our lab. Each user held the MESH hardware as it displayed a 250 Hz sine wave, and adjusted the amplitude until they could no longer feel the vibration. These data were averaged to calculate the perceptual minimum for the MESH hardware. Contrasting these against the maximum amplitude revealed a dynamic range of 54 dB.

The playback circuit is an electronic subsystem within MESH consisting of the output transducers 123-127, the drivers 143-147 and the D-to-A converter 134 which receives digital signal samples from the microcontroller 125. This subsystem enables the IPAQ to upload samples to the expansion jacket, and then play them back using the vibrotactile transducers with short commands transmitted over the RS232 serial link. The hardware supports eight different samples simultaneously. Each sample has a resolution of 8 bits, is a maximum of 256 bytes long and is output at a rate of 1 kHz. This gives each sample a maximum duration of 256 ms. Samples can be looped to provide a continuous vibration. A number of parameters can be adjusted dynamically including the sample amplitude and the start and end position used within each sample. This system allows an application to display a wide range of customized high-fidelity vibrotactile effects for very little processor overhead. Samples can be displayed perceptually instantaneously, and with little impact on the iPAQ's main CPU. 3

Analysis of the Interaction Space

Movement is an extremely rich input channel, and even for the relatively simple task of scrolling, the accelerometers and vibrotactile display within the MESH hardware platform permit a wide range of potential interaction techniques. We have made several general observations about the kinds of input and output we can support and, to frame the subsequent discussion, these are outlined briefly below.

Broadly speaking, the accelerometers 103-107 within the MESH platform support two forms of scrolling input: discrete and continuous control. Discrete control involves monitoring the accelerometer input for specific patterns and mapping them to individual scrolling events. The simplest example of this kind of control is to generate a single scroll event when the acceleration value crosses a certain threshold in only one direction. This transforms the analog input from the accelerometers into a binary input, resulting in button-like behavior. Harrison et al. {See Ref. 4} use accelerometers and discrete control to turn the pages in a handheld book reader, and we speculate that it would be useful for many similar purposes, such as selecting songs on a MP3 player, or specific items from menus.

A number of different metaphors exist for continuous control, but they can be characterized by the use of the full range of the accelerometer input to adjust the scrolling position. We describe three possible metaphors, termed position control, rate control and inertial control. Position control uses the orientation of the handheld device to control the absolute position in a given scrolling space: as the device moves from being face-up to face-down in one axis, the entire range available for scrolling is linearly traversed. One potential advantage of this technique is that it is very direct. It can leverage a user's proprioceptive sense to close the control loop. If a particular scroll location is always available when the device is horizontal, then users can use this physical stimulus to confirm they have reached their desired destination. This input metaphor featured in the miniature text entry system described by Partridge et al. {See Ref. 8}.

Rate control refers to mapping the orientation of the device to the rate of scrolling. As the device is rotated further from a neutral orientation, the speed of scrolling increases. Again, this mapping is relatively natural; many everyday controls respond in this way. If you push harder on a car's pedals, the affects on the vehicle's velocity are more extreme. This kind of mapping has been used to control scrolling in canvases such as maps {See Ref. 3, 5}.

Finally, inertial control suggests that the orientation of the handheld device could be used to adjust scroll speed through the metaphor of a virtual mass. As the device is tilted the mass gains momentum, and begins to move. This movement is associated with scrolling. To stop scrolling, the momentum of the mass must be overcome. Weburg et al. {See Ref. 9} suggests that this technique might be used to control cursor position, but it is unclear what benefits it might offer over rate control.

Vibrotactile display Graphical scrolling operations are supported by a number of different visualizations: highlighting is used to indicate the current location and a scroll bar shows the overall position within the scrolling space. Similarly, the vibrotactile modality can support a number of different visualizations. Here, we describe three such visualizations: rate display, position display and contextual display. This discussion does not seek to describe the physiological parameters that can be leveraged to create maximally distinct or effective vibrotactile stimuli (for a good review of this topic, see van Erp {See Ref. 10}), but instead to describe how such a set of stimuli might be meaningfully employed.

Rate display refers to using the vibrotactile output to display the rate of motion. This can come in a number of forms, from generating a brief pop or click on the transition from one list item to the next (as in Poupyrev et al. {See Ref. 6}), or when a grid line is crossed on a map, to adjusting the magnitude of a continuous waveform according to the scrolling speed. Both of these mappings result in a similar display; as scrolling speed increases the frequency at which a brief stimuli is felt, or the magnitude at which a continuous stimuli is displayed also increases. This creates a link between stimuli magnitude and scroll rate, and resembles the role of highlighting in graphical scrolling operations. A user is informed of the change in scroll position by the change in highlighting. Position display, on the other hand, refers to using some dimension of the vibrotactile output to display the absolute position in the scroll space. For example, as a list is traversed from one end to the other, the magnitude of a vibrotactile waveform could be linearly adjusted through the entire range of its scale. In this example, the vibrotactile output functions similarly to a graphical scrollbar: it serves to indicate a user's overall position in the scrolling area, and may be too coarse to register small changes.

Finally, vibrotactile feedback can be used to advantage to display information relating to the content being browsed. This kind of contextual display could be implemented in many ways. Good examples might be providing distinct vibrotactile feedback on the transitions between items in an address book when a commonly called number is reached, or varying the magnitude of a continuous waveform according to the distance to significant objects on a map. Feedback of this sort is extremely application specific, but has the potential to yield rich and meaningful interactions.

The invention has been used to implement vibrotactile-tilt scrolling interfaces for two different scenarios. The first scenario was that of an address book. Address books are probably the most commonly used mobile application; they are employed almost every time a call is made or a message sent. Their interfaces are therefore extremely important, and we believe well suited to an interaction comprised of tilt input and vibrotactile display. Essentially, an address book is a list, a one-dimensional scrolling space. Poupyrev et al. {See Ref. 6} describe a study investigating the navigation of such a space using rate control tilt input and rate display vibrotactile output. Tilting the device adjusted the rate at which the list was traversed, and the vibrotactile feedback was used to indicate the transition from one item to the next. They studied whether or not the addition of vibrotactile feedback aided the scrolling operation, and showed that it did; both task completion time and distance scrolled were reduced in the condition incorporating the vibrotactile display. However, they did not contrast performance using the tilt interface to more conventional button or thumb wheel interfaces.

As we explored the specific scenario of an address book, we came to the conclusion that using rate control and display was not the optimal solution. As Poupyrev points out, users experience difficulties in targeting specific items, often overshooting their desired destination and then finding it hard to make small adjustments to position themselves correctly. We suggest that a better solution can be designed using a combination of position control, haptic position display and the key based interfaces commonly used in existing address book applications.

The interaction can be described as follows: a user selects a key from a phone style arrangement of 9 keys, 8 of which are associated with the typical groups of 3 or 4 letters (such as abc and def). Holding this key down enables a tilt scrolling interaction with the range available for scrolling restricted to names that begin with the letters associated with the selected key. The scrolling range is mapped to a 90-degree change in orientation such that holding the device horizontally selects the first available item, and holding it vertically selects the last. Users can then select a specific list position by relying on their proprioceptive sense—by simply moving to a specific orientation. Additional vibrotactile feedback supports this interaction in the form of a continuous 250 Hz vibration. As the user moves from one end of the scroll space to the other the amplitude of this waveform is adjusted from a perceptual minimum to the maximum supported by the display hardware. Commonly chosen items are marked by altering the pitch of the vibration to 280 Hz. Releasing the on-screen key causes the currently highlighted address to be selected.

The second scenario we have considered is that of viewing and navigating maps. This is a uniquely mobile domain: maps are often perused while on the move and in distracting conditions (such as those caused by the weather, or by being engaged in another task). Exacerbating these problems is the fact that maps often represent unfamiliar material. For these reasons, map display software has proven successful in mobile scenarios ranging from in-car navigation systems to tourism applications on PDAs {See Ref. 11}.

On small screen devices, it is rare that the entirety of a map can be displayed at a comfortable resolution; due to the density of the information, effective scrolling techniques are an essential part of any map viewing software. Furthermore, viewing a map often takes the form of browsing, of relatively undirected searches of the entire space for specific pieces of information. This kind of search is dependant on a well-designed scrolling mechanism. Tilt input has been suggested as a means to scroll map data by a number of previous authors {See Ref. e.g. 3, 5}, and although no formal evaluations have taken place, qualitative improvements have been reported. The addition of vibrotactile feedback as contemplated by the invention will provide additional benefits to this interaction.

We have looked at two mechanisms by which we can support tilt-based scrolling with vibrotactile display: using rate display to represent the scroll speed, and using contextual display to highlight specific information that is currently on screen. These explorations were inspired by the observation that it is desirable to navigate around maps using as little visual attention as possible, preferably only tying gaze to the screen when significant objects are already known to be visible.

Our initial explorations dealt with rate display. We began investigating the simultaneous presentation of two separate streams of rate information, one for motion along each axis. We attempted to achieve this by varying the intensity of two continuously displayed vibrations of different frequencies, but (due to the limitations of both our abilities to sense small differences in vibrotactile pitch and the limitations of our transducer) found they tended to merge into a single stimulus. A second approach involved displaying distinct short haptic pops as map gridlines were crossed. Again, we associated a different stimulus for motion in each axis, but attempted to capitalize on our ability to distinguish overlapping temporal patterns to display the motion, rather than to monitor two simultaneously presented stimuli. We found this technique to be much more effective. However, when scrolling rapidly, the display became somewhat confusing. The density of vibrotactile stimuli led to a masking effect, where the discrete stimuli began to merge into one another. This observation led us to examine rate displays with a lower density of information. We mapped the intensity of two different continuous vibrations (220 and 280 Hz) to acceleration and deceleration in scrolling speed, and overlaid this with a third unchanging low intensity 250 Hz vibration that was displayed whenever scrolling was taking place. Although this system did not attempt to distinguish between motion in the different axes, it did support users as they attempted to control their scrolling speed. Informally testing this technique, we felt that it strongly aided users as they tried to position themselves accurately on a canvas. It provided them with increased levels of control and confidence as they attempted to make small scale targeting movements, addressing a problem that has been consistently reported by other authors investigating tilt scrolling interfaces {See Ref. e.g. 4, 6}.

Maps are very rich information spaces. Contextual display of this information has the potential to support very rich interactions. We experimented with a number of techniques. Initially, we examined the idea of supporting users tracing a specific visually marked route around a map, such as a road or train line. We displayed the range from the path as a continuous vibration that increased in amplitude with increased distance. At the same time we decreased the sensitivity of the tilt scrolling, so movement became more gradual at the same degree of tilt the further one moved from the path. This created the illusion that the vibration represented a friction-like force opposing the scrolling motion, and felt both easy and pleasing to use. We believe that this combination would support path following while demanding relatively little visual attention.

We also considered how to support map browsing. Taking the example of maps augmented with specific meta-information (such as the location of food stores or restaurants) we explored how the vibrotactile channel could be used to display this information without the clutter of continuous visual presentation. In this scenario, as a user scrolls near an area possessing some desired service or object, a vibration is displayed, with its intensity varying with the distance to the object. Staying within the area demarked by the vibration feedback for greater than a certain period of time (in our case half a second) triggers a distinct brief haptic stimuli and a visual highlight containing specific information about the object that has been discovered. This technique enables a kind of simple haptic targeting; it enables a user to select objects using nothing but tilt input and vibrotactile display. Informal experimentation with this technique led us to conclude that even though the vibrotactile feedback is not directional, it is relatively easy to purposefully steer to or from the highlighted areas and engage the selection. The proprioceptive feedback inherent in the scrolling is directional, and consequently the changes in vibration amplitude provide sufficient cues to support the navigation.

MESH hardware can be constructed that employs 2 DOF magnetometers, 3 DOF gyroscopic sensing of device rotation and extended output capabilities in the form of a stereo vibrotactile display consisting of at least two mechanically isolated transducers. The capabilities permit us to stimulate either side of the device separately and, given the ergonomics of a PDA, enable the display of distinct signals to the fingers and to the palm and thumb. The use of plural output transducers provide a considerably richer output channel and support more sophisticated vibrotactile interfaces.

The data acquisition unit shown in FIG. 1 consists of two parts, the analog part, and the digital part. The analog part is centered about an 8-channel, 12-bit analog to digital converter 120. The A-to-D converter 12 may be implemented with a TLC3548 14-bit, 5V, 200KSPS, 8-Channel Unipolar ADC available from Texas Instruments. It communicates to the microcontroller 125 using the SPI serial protocol and operates at a sample rate of 1 kHz, allowing the sensing elements to operate to a bandwidth of 50 Hz without introducing any aliasing error. The sensing elements that are sampled in this fashion include three accelerometers 102-107, three angular rate sensors (Gyros) 113-117, and a temperature sensor (not shown, for calibrating the inertial measuring devices). The inertial measurement sensors (the accelerometers and gyros) are filtered in the analog domain by the low pass filters 119, with 4th order Gaussian low-pass filters, based around sallen-key topologies. The Gaussian design was chosen for its linear phase response—its step response is critically damped. The gyro sensors may be implemented using The ADXRS300 device available from Analog Devices, a 300 degree per second angular rate sensor (gyroscope) on a single chip, complete with all of the required electronics.

The microcontroller used to implement the MESH expansion jacket was a PIC16F877AM available from Microchip. This CMOS FLASH— based 8-bit microcontroller incorporates features 256 bytes of EEPROM data memory, self programming, an ICD, 2 Comparators, 8 channels of 10-bit Analog-to-Digital (A/D) converter, 2 capture/compare/PWM functions, the synchronous serial port can be configured as either 3-wire Serial Peripheral Interface (SPI™) or the 2-wire Inter-Integrated Circuit (I²C™) bus and a Universal Asynchronous Receiver Transmitter (USART).

The digital part of the data acquisition operates at a lower update rate, and gathers data from the magnetic compass sensors seen at 153 and 155, and a GPS (Global Positioning System) module 157. Both of these sensors have bandwidths that are much lower than the inertial measurement units, and in this design the sampling occurs at approximately 10 Hz. The magnetic compass sensors (2 of) communicate with the microcontroller using the 12C serial protocol, and the GPS uses DART serial protocol. The magnetic compass sensors 153 and 155 may be implemented using The Honeywell HMC6352 two-axis magnetic sensor with the required analog and digital support circuits for heading computation. The GPS module may be implemented using a Trimble Lassen SQ GPS Module, a low-power, micro-sized 8 channel GPS device designed for use for mobile products available from Trimble Navigation Limited of Sunnyvale, Calif.

All of the data gathered is digitally processed and packaged within the microcontroller, and every 10 ms, the host IPAQ 110 is interrupted, to notify it that the data is waiting to be read. The IPAQ interrupt service routine then grabs the data in a series of reads from the microcontrollers parallel slave port.

The data display is currently implemented as three channels of vibration output. There are three ways that this data to be displayed can be transferred to the actuators. The first is that the host IPAQ 110 can send audio data over its expansion connector, and route it directly to the vibrotactile driver amplifiers 132-147. The second method is to write data directly to a 4 channel digital to analog converter 135 connected to the parallel expansion bus. The DAC converter 135 may be implemented with a MAX5742 converter available from Maxim Integrated Products of Sunnyvale, Calif.

The third method is the most complex, but provides great efficiency and minimal interruption to the iPAQ's main processor. It operates as a sample playback device, running within the microcontroller. The host iPAQ just needs to send simple commands to trigger the playback of vibration samples that are stored within the microcontrollers flash program memory. The host iPAQ 110 can trigger up to 16 different samples, each of 0.25 seconds long, and can implement functionality such as sample looping, amplitude control, and in and out points. The host iPAQ can also upload new samples to the microcontroller 125 on demand.

The tactile data displays typically have a bandwidth of 1 kHz, beyond this our perceptual threshold to vibration is too large. The display transducers can plug into the main board of the expansion jacket using small surface mount connectors, allowing a range of different devices to be used. The vibration signals from the three sources mentioned previously are mixed together and power amplified using class-D bridged audio amplifier ICs 143-147. These provide a maximum of 2 W output power into 4 ohm load, and a peak-peak voltage swing of 6.2V.

Two of the three vibration displays are meant to provide a method of imparting a degree of directionality to the pocket PC user. They take the form of small electromechanical transducers, with a metal surface. In this design, these metal surfaces are connected to a capacitance sensor, which allow the host IPAQ to be aware of whether the user is in contact with them or not. These surfaces can effectively be used as tactile touch switches, with immediate and programmable feedback to the user about the state of the switch. It also allows for energy saving, since the vibration can be eliminated when it is not needed.

In summary, the technology which Mesh incorporates has the potential to be integrated into any mobile or hand-held electronic device such as mobile phones, personal cameras, pocket PCs or MP3 or other media players, providing them with a gestural interface that allows for tilting interaction or more complex gestural input. Furthermore, the vibrotactile display capability of Mesh supports interactions which are non-visual, so making the devices easier to use while on the move.

As a demonstration of an application that combines gestural input and vibrotactile display, we have written a simple tilting maze game. In this game, tilting the hand-held device causes a virtual ball to roll around a maze. The speed of the ball and its rebound behavior when it reaches a virtual barrier are determined by the tilt of the device. Moreover, as the ball rolls, friction between it and a virtual surface is simulated as vibration which can be felt in the hand while the impact caused by a collision with the maze's wall is simulated as a discrete vibrotactile ping.

The invention may be used in combination with system of the type described in copending U.S. patent application Ser. No. 11/096,715 filed on Apr. 1, 2005 by Maire Sile O'Modhrain, Ian Oakley, Stephen Hughes and Cormac Cannon, which is incorporated herein by reference. The invention may be used to augment the capabilities of a handheld TV remote control, so that gestural movements control the operation of a connected TV set (for example, controlling the scrolling and selection of items displayed on an electronic program guide listing). In addition the combination of audiovisual data and haptic “touch” data may delivered to the observer in real time as a portrayed activity takes place; for example, the viewer may watch and listen to a live sports event while simultaneously receiving touch data that can control the vibrotactile transcducers 123-127 seen in FIG. 1 that produce haptic stimuli perceptible by the observer and that enhances the observer's sense of participation in the event. In the arrangement described in the copending application, the event data which controls the vibratory stimulation is preferably combined with the audiovisual data to form a composite signal that is broadcast from the program source to a remote receiver which reproduces the signal for one or more human observers. The composite signal may consist of an analog television signal in which the event data is encoded for transmission in the vertical blanking interval, or as an ancillary data signal transmitted with a digital television signal. At the receiving location, the event signal is extracted from the received composite signal for reproduction by one or more haptic transducers. The motion sensors in the TV remote control may be used in combination with means for generating vibratory feedback to control such things as volume, channel switching, playback control for DVD and DVR recordings, and other functions now commonly controlled using pushbuttons on a conventional remote control unit. The operation of many other systems can be controlled using the invention, to provide, for example:
a versatile interface for mobile computing devices such as phones, PDAs, MP3 players and other hand-held computers;
an enhanced system for displaying streamed media content such as music, sports, etc. where limited audio and video capabilities of small devices are enhanced by the addition of an extra channel of sensory feedback in the form of haptic feedback;
an enhanced communication device, where haptic feedback can enrich interpersonal communication by allowing for mediated touch in interpersonal interaction;
enhanced SMS messaging, where text messages can be accompanied by touch messages;
mobile gaming, where events in a game can be felt as well as seen or heard, e.g. haptic guidance through a complex mixed-reality on-street game, or mobile pong where a ball can be felt as well as seen; and
eyes-busy interaction, where gestural input and haptic output can take the place of the PDA's on-screen interface in many common interaction tasks such as selection of items through the motion of the hand and task status monitoring through haptic display.

### REFERENCES

1. Pirhonen, A., S. A. Brewster, and C. Holguin. Gestural and Audio Metaphors as a Means of Control for Mobile Devices. in ACM CHI'02. 2002. Minneapolis, Minn.: ACM Press.
2. Ehrlich, K. and A. Henderson, Design: (Inter)facing the millennium: where are we (going)? interactions, 2000. 7(1): p. 19-30.
3. Rekimoto, J., Tilting Operations for Small Screen Interfaces. UIST, 1996.
4. Harrison, B. L., et al. Squeeze me, hold me, tilt me! An exploration of manipulative user interfaces. in ACM CHI'98. 1998. Los Angeles, Calif.: ACM Press.
5. Hinckley, K., et al. Sensing techniques for mobile interaction. in ACM UIST'00. 2000. San Diego, Calif.: ACM Press.
6. Poupyrev, I., S. Maruyama, and J. Rekimoto. Ambient touch: designing tactile interfaces for handheld devices. in ACM UIST'02. 2002. Paris, France: ACM Press.
7. Audiological Engineering Corp, 2004, www.tactiad.com
8. Partridge, K., et al. TiltType: accelerometer-supported text entry for very small devices. in ACM UIST'02. 2002. Paris, France: ACM Press.
9. Weberg, L., T. Brange, and A. W. Hansson. A piece of butter on the PDA display. in ACM CHI'01. 2001. Seattle, Wash.: ACM Press.

### CONCLUSION

It is to be understood that the methods and apparatus which have been described above are merely illustrative of the principles of the invention. Numerous modifications may be made by those skilled in the art without departing from the true spirit and scope of the invention.

What is claimed is:

1. A motion sensing and vibrotactile feedback system for controlling a hand held device comprising, in combination,
acceleration sensors for performing 3-axis inertial data indicative the motion of said hand held device as it is held by and manipulated by a device user,
one or more vibrotactile transducers positioned on the body of said device and positioned to contact the hand of said device user,
one or more user-operated control devices,
means coupled to said acceleration sensors and to said one or more user-operated control devices for producing input control signals for controlling the operation of said device, and
means responsive to output signals received from said device which are indicative of the state or operation of said device for actuating said vibrotactile transducers to provide a sensory indication of said state or operation to said device user.
